(19) United States
(12) Patent Application Publication
(10) Pub. No.: US 2013/0162462 A1
(43) Pub. Date: Jun. 27, 2013

(54) Method and Arrangement for the Acquisition of Measurement Data of a Vehicle in a Radar Field

(71) Applicant: JENOPTIK Robot GmbH, Monheim (DE)

(72) Inventor: Michael LEHNING, Hildesheim (DE)

(73) Assignee: JENOPTIK Robot GmbH, Monheim (DE)

(21) Appl. No.: 13/722,533

(22) Filed: Dec. 20, 2012

(30) Foreign Application Priority Data
Dec. 22, 2011 (DE) DE102011056861.1

(51) Int. Cl. G01S 13/58

(52) U.S. Cl. CPC G01S 13/58
USPC 342/104

(57) ABSTRACT

Method and arrangement for the acquisition of measurement data of a vehicle (4) traveling through a radar field (2), wherein a reflector (7) is arranged in the radar field (2). Direct and indirect reflection signals are received from the vehicle (4), and direct and indirect measurement data are derived which are suited to be checked for correlation with one another so as to rule out measurement of the vehicle (4) through bent beam reflection.

### RELATED APPLICATIONS

The present application claims priority benefit of German Application No. DE 10 2011 056 861.1 filed on Dec. 22, 2011, the contents of which are incorporated by reference in their entirety.

### FIELD OF INVENTION

The invention is directed to a method and an arrangement for the acquisition of measurement data of a vehicle in a radar field such as is known generally from DE 10 2007 022 373 A1.

### BACKGROUND OF THE INVENTION

Radar measuring devices rank among the main measuring instruments for monitoring and enforcing legal speed limits for vehicles. In order for measuring devices of this kind to be approved for use in conformity with regulations, the correctness of the measured speed must be ensured and made plausible on one hand and it must be possible to associate the measured speed with a vehicle to the exclusion of all doubt on the other hand.

The invention is directed to a method and an arrangement which establishes the plausibility of the measured speed, and ensures that this measured speed was not acquired through a measurement of a vehicle by bent beam reflection.

The fact that there are measurement conditions under which it is impossible to associate the measured speed with the measured vehicle with absolute certainty is substantiated by the principles of radar technology. Radar radiation ordinarily forms a radar field which propagates at an angle of approximately 5° to 10° and correspondingly increases in breadth as the distance from the radar transmitter increases, so that a plurality of vehicles can be located within the radar field simultaneously when used on a roadway having multiple lanes.

So-called bent beam reflections can cause problems in carrying out radar measurements. In such cases, radar beams which are reflected by an object arrive back at the receiver of the radar device by way of a reflecting object located in the radar field. As a result of these unintended reflection signals, a virtual object is detected in a position in which the object is not actually located. A method, a radar device and an arrangement by which ghost images can be detected are known from DE 103 11 959 A1. The solution disclosed in DE 103 11 959 A1 is intended for use in a moving vehicle. In this respect, it is problematic that a radar field radiated from a moving vehicle is subject to persistent and unknown influences and sources of interference, one result of which is the unwanted occurrence of ghost images. A first region and a second region are established in a detection zone (radar field) of the radar device, and various units are employed to assess whether or not another lane is present alongside the lane on which the vehicle having the radar device is driving at that instant, whether or not and in which of the zones an object is detected, and whether or not a detected object is located on a detected lane. In so doing, the cause of the ghost image is not significant; only its presence is evaluated.

In order to positively identify a measured vehicle, i.e., a vehicle reflecting the radar radiation, that is, in order to detect the measured vehicle within a group of vehicles, it is suggested in EP 0 935 764 B1 that the distance also be detected simultaneously with the speed and that the vehicle be associated with a lane by means of the detected distance.

In contrast to the measurement of speed, which can be measured very precisely, the range of variation in distance measurements is very wide. There are a number of reasons for this. Thus the point reflections arriving at the radar antenna from a vehicle extend to the entire contour of the vehicle on which the radar radiation is projected. The cross section of the radar radiation projected on a vehicle traveling through the radar field changes depending on the given geometry of the vehicle and on its position in the radar field between entering and exiting the radar field. Therefore, a sum of measurement values from partial reflections is detected by the radar receiver at each measurement time. Statistically, this sum is generally received together with other parasitic reflectors, such as guard rails or metal fences, as a Rayleigh distribution. Distances are measured which can be scattered on the order of magnitude of the roadway width and vehicle dimensions.

A positive identification of a vehicle from averages formed therefrom is not possible with any certainty owing to the different reflection behavior of the vehicles and possible multiple reflections.

Even when measured values outside of a predefined tolerance range are ignored and the average is formed only from the remaining measured values so as to rule out corruption of the averaged distance value due to partial reflections on parasitic reflectors, an identification based on the averaged distance value and association thereof with a roadway is not possible in every measuring situation.

With the aim of positively associating measurement values with a vehicle, it is suggested in DE 10 2007 022 373 A1 to derive measurement values repeatedly and continuously over the duration of the passage of the vehicles through the measuring zone, to assess the plausibility of previously measured values by means of subsequently derived measurement values, and to determine from the measured distance values the lane in which the measured vehicle is traveling and which can be projected as a mark into an image for identifying the vehicle.

A drawback of this method in particular is that erroneous measurements, e.g., due to bent beam reflections, are not ascertained until the image is evaluated. This reduces the trustworthiness of the measurement process on a subjective level.

It is also known to carry out measurements with two measuring arrangements so that the correctness of measurement values can be confirmed if necessary and measurement by bent beam reflection can be eliminated. However, this calls for doubling the outlay on apparatus.

### SUMMARY OF THE INVENTION

It is an object of the invention to find a method and an arrangement by which it can be established with certainty and with modest measurement resources that the measurement values obtained from a vehicle are not caused by bent beam reflection.

The above-stated object is achieved through a method for the acquisition of measurement data of a vehicle traveling through a radar field in which radar radiation proceeding from a radar device and defining a radar field with a radar axis is directed horizontally over a roadway, and a first portion of the radar radiation at a vehicle traveling through the radar field in a driving direction is reflected directly back to the radar device. The first portion of the radar radiation is detected by the radar device in the form of direct reflection signals. Direct measurement data of the vehicle are derived from the direct reflection signals.

The method according to the invention is characterized in that at a reflector which is arranged within the radar field at a known installation distance from the radar device and which has a reflector axis forming an alignment angle with the radar axis, a portion of the radar radiation is reflected into a reflection field forming a subregion of the radar field so that, simultaneous with the first portion, a second portion of the radar radiation at a vehicle passing through the reflection field is reflected back to the radar device indirectly via the reflector. The portion of radar radiation that is reflected back indirectly is detected in the form of indirect reflection signals, and indirect measurement data of the vehicle are derived from the indirect reflection signals. The direct and indirect measurement data which are obtained simultaneously are checked for correlation. Correlation between the measurement data is proof that these measurement data are not caused by bent beam reflection.

A vehicle traveling through the radar field is directly measured at another measurement point in each instance at a plurality of measurement times. By measurement point is meant the position of the reflecting surface of the vehicle reduced to a point, which position is defined by a representative distance value and representative angle value from the sum of all distance measurement values and angle measurement values derived at a measurement time. That is, a measurement point is defined by a distance value and an angle value with respect to the radar device and the reception surface of the radar receiver with the radar axis, respectively. From every measurement point, direct reflection signals are received by the radar device and direct measurement data are derived. In contrast, there is only one measurement point at which indirect reflection signals can be received by the radar device and indirect measurement data can be derived.

The reflector is arranged at a known installation distance from the radar device which is determined when the reflector is installed. The installation distance is defined by the shortest distance between the center of the reflector, equal to the intersection of the reflector axis on the reflector, and the center of the reception surface of the radar receiver, equal to the point of intersection of the radar axis.

As used herein, direct reflection signals mean such reflection signals as proceed from radar radiation which propagates on a direct path from the radar device to a measurement point (direct distance) and is reflected back at this measurement point on a direct path from the vehicle to the radar device. The measurement data derived from these direct reflection signals are referred to as direct measurement data, where “direct” refers to the direct path of the radar radiation and not to a specific mode of deriving the measurement data. The direct distance is measured in each instance. Another measurement point is acquired at every measurement time from a vehicle traveling through the radar field via the reception of direct reflection signals.

The above statements apply to the indirect reflection signals and the indirect measurement data providing that the path of the radar radiation runs through the reflector (equal to the installation distance). A second portion of the radar radiation is reflected back to the radar device at a measurement point from the vehicle via the reflector and is received at the radar device as indirect reflection signals. A measurement point is acquired from a vehicle traveling through the radar field by the reception of indirect reflection signals.

The total distance from radar device through reflector to measurement point is referred to as the indirect distance whose length is measured. The distance between the reflector and measurement point is referred to hereinafter as the partial distance and is calculated as the difference of the measured indirect distance and the installation distance.

The reflector axis extending perpendicular to the center of the reflector intersects the radar axis at an intersection point and forms the alignment angle with the radar axis. This alignment angle need not be known, but it is essential that the alignment angle be selected in such a way that the measurement point from which indirect reflection signals can be acquired lies within the radar field.

A portion of the radar radiation proceeding from the radar device impinges on the reflector and is reflected by the latter into a reflection field. This reflection field at least partially overlaps the radar field.

The expression “correlation” means within the meaning of the description that the direct measurement data and the indirect measurement data have at least a certain mathematical relationship to one another. The measurement data may lie within a determined tolerance range. For example, the speeds of the vehicle derived from the direct and indirect reflection signals (e.g., a first speed derived from the direct reflection signals and a second speed derived from the indirect reflection signals) can diverge from one another by less than 2 km/h and still meet the correlation conditions.

A direct radial velocity and a direct position angle are preferably derived from the direct reflection signals as direct measurement data at least at one measurement time.

Knowing an installation angle, the direct radial velocity and the indirect radial velocity are checked for correlation in order to deduce, if necessary, as a first proof that the direct measurement data and the indirect measurement data are caused by a same vehicle and were not measured by bent beam reflection.

The direct radial velocity is that portion of a velocity vector of the vehicle that is directed and measured in direct direction from the vehicle to the radar device. Accordingly, the vehicle moves toward the radar device at the direct radial velocity. The above statements apply to a vehicle moving away from the radar device but in this case the direct radial velocity is negative.

The direct position angle is the angle between the radar axis and a length describing the direct distance between radar device and measurement point and changes with the movement of the vehicle through the radar field.

In a corresponding manner, an indirect radial velocity and an indirect position angle are derived from the indirect reflection signals as indirect measurement data. In this regard, the indirect radial velocity is that portion of the velocity vector of the vehicle that is directed from the measurement point directly to the reflector.

The indirect position angle is the angle between radar axis and that distance whose length describes the installation distance. The indirect position angle is measured and is constant.

Either the angle between the radar axis and the driving direction of the vehicle or the angle which forms the radar axis with the edge of the roadway can be taken into account as installation angle.

### SUMMARY OF THE EMBODIMENTS

In a simple first embodiment of the method according to the invention, the installation angle is understood to mean the angle between the edge of the roadway and the radar axis and is assumed to be known in that it was specifically established when installing the radar device. This installation angle will be designated hereinafter as first installation angle.

In a second embodiment of the method, the installation angle is understood to mean the angle between the driving direction of the vehicle and the radar axis, which angle can be determined anew in relation to the specific vehicle with each measurement process. Further, the change in position, and therefore the driving direction of the vehicle, is determined from the direct measurement data of a plurality of measurement times and the installation angle is calculated as angle between the radar axis and the driving direction. This installation angle will be referred to hereinafter as second installation angle.

In view of the fact that the second installation angle is understood during the measurements, the results are more precise in case the vehicle is not driving exactly parallel to the roadway edge during detection on the one hand and, on the other hand, the radar device need not be arranged in a precise manner during installation. Also, subsequent misalignments of the radar device do not lead to erroneous measurement results.

In all cases in which the driving direction does not run parallel to the roadway edge, the first installation angle and second installation angle diverge from one another.

The correlation between measurement data is checked in that a speed of the vehicle in a driving direction is derived from the direct radial velocity and from the indirect radial velocity, and the derived speeds are then checked for conformity as to whether they deviate from one another by less than a predetermined tolerance range.

This tolerance range can be a fixed absolute or relative (e.g., percentage) value. In further embodiments of the method according to the invention, the tolerance range can also be derived from measurement data (e.g., variances or standard deviations of previous or current series of measurements). The tolerance range can be defined statically or dynamically. When a correlation is established, this presents a first proof that the direct measurement data and the indirect measurement data are caused by a same vehicle.

The method according to the invention can also be configured in such a way that a direct distance is derived from the direct reflection signals as direct measurement data and an indirect distance is derived from the indirect reflection signals as indirect measurement data and, knowing the installation distance of the direct and indirect position angles, correlation of the direct distance with the indirect distance is checked. The aim of this procedure is to derive a second proof, if necessary, that the direct measurement data and the indirect measurement data are caused by a same vehicle.

It is further possible that checking of correlation is carried out in that a partial distance is derived from the direct distance on one hand and from the indirect distance on the other hand, and the derived partial distances are checked for conformity.

The possibilities enumerated above for checking correlation can also be combined in further embodiments. A combination advantageously allows two highly mutually independent measurement data to be checked, which improves the reliability of the check.

In further embodiments of the method according to the invention, additional distances and angles can also be measured or calculated. These additional distances and angles can be used directly for checking the correlation or for indirectly deriving additional positional relationships between radar device, reflector, vehicle, roadway, etc.

In applying the method according to the invention, the vehicle traveling through the radar field is detected over the duration of transit at a quantity of measurement points, and direct measurement data (e.g., speed, position angle, distance) are derived. This procedure, known as tracking, allows the respective derived direct measurement data to be compared with one another and checked for consistency, i.e., for the likelihood that the direct measurement data are correct.

While the direct measurement data can be derived at a quantity of measurement points, there is only one measurement point at which indirect reflection signals are also reflected back to the radar device from a target object. Indirect measurement data of different detected vehicles can be compared with one another so that the consistency of indirect measurement data can also be checked.

This relates in particular to the indirect distance between measurement point and radar receiver measured via the reflector and to the associated indirect position angles.

The proof that both measurements are to be attributed to one vehicle confirms that the vehicle was not measured through bent beam reflection. If the proof cannot be produced, the measurement results are rejected and no documentation takes place. This has the particular advantage over the prior art that it is not only through subsequent evaluation that an erroneous measurement is discovered, which can convey the subjective impression that erroneous measurements are always entirely possible.

The above-stated object is further met through an arrangement for the acquisition of measurement data of a vehicle traveling through a radar field. The arrangement has a radar device which includes a radar transmitter and a radar receiver. The radar transmitter is suited to emit a radar radiation which is directed over a roadway and defines a radar field with a radar axis that forms an installation angle with a roadway edge or the driving direction of a vehicle. The arrangement is characterized in that a reflector having a reflector axis that forms an alignment angle with the radar axis is so arranged within the radar field at a known installation distance from the radar device that the reflector reflects a portion of the radar radiation via the reflector into a reflection field forming a subregion of the radar field so that the radar receiver receives direct and indirect reflection signals simultaneously from a measurement point of a vehicle traveling through the reflection field, and a computing/storage unit is connected to the radar device and configured to derive measurement data from the direct and indirect reflection signals and to check for correlation between these measurement data.

In an advantageous embodiment of the arrangement according to the invention, the reflector is a retroreflector with reflection surfaces which form an angle with one another that is greater than 90° and less than 180°.

The reflection behavior of a reflector configured in this way is invariant with respect to rotation around its vertical axis. For example, with a scenario built from the components comprising passenger car (PKW), mirror, and antenna with a plane mirror, even the slightest rotation of the mirror (e.g., around the vertical axis) leads to a change in the relationship between the components. On the other hand, if the modified retroreflector is used instead of the mirror, the angle defined between PKW, retroreflector and antenna always remains the same even if the retroreflector is rotated around its vertical axis. This is essential to the invention and makes it suitable for routine use.

In further embodiments of the arrangement according to the invention, a plurality of retroreflectors can also be provided. Shadowing, for example, can be detected with an arrangement of this kind.

### BRIEF DESCRIPTION OF THE DRAWINGS

The invention will be described more fully in the following with reference to an embodiment example and the annexed drawings. In the drawings:

FIG. 1 is a schematic diagram showing an arrangement according to the invention;

FIG. 2a is a graph showing the parameters for a first proof;

FIG. 2b is a graph showing the parameters for a second proof; and

FIG. 3 shows an embodiment of a reflector according to the invention.

### DESCRIPTION OF THE EMBODIMENTS

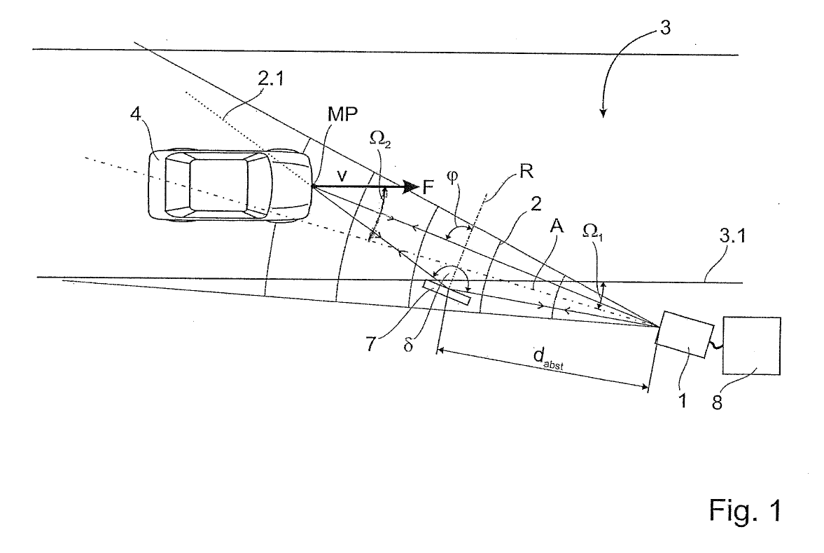

FIG. 1 is a schematic diagram showing essential components of an arrangement according to the invention including a radar device 1 installed at an edge 3.1 of a roadway 3 and a reflector 7 arranged in the radar field 2 of the radar device 1.

The radar field 2 is defined by a radar radiation which is emitted by the radar device 1 in direction of a radar axis A at a beam angle. FIG. 1 shows the spread of the radar field 2 in a horizontal plane.

The reflector 7 is a plane mirror so that the reflector axis R corresponds to a surface normal. Radar radiation impinging on the reflector 7 is reflected by the latter into a reflection field 2.1 describing a vertical plane in the direction of the radar radiation reflected by the reflector 7 and lies within the radar field 2.

The radar device 1 is installed at the edge 3.1 of a roadway 3 in such a way that the radar axis A is directed over the roadway 3 at a first installation angle Ω₁ to the roadway edge 3.1. At a known installation distance d_{abst} predetermined by the installation, the reflector 7 is so arranged and aligned that the reflector axis R extending perpendicular to the reflector 7 intersects the radar axis A in the region of the roadway 3 at an alignment angle Ψ.

The reflector 7 is so configured that radar radiation propagating along the length of the installation distance d_{abst} impinges on the reflector 7, is reflected at a reflection angle δ, and forms the reflection field 2.1.

For purposes of comprehending the arrangement and describing the method which can be carried out with the arrangement according to the invention, FIG. 1 also shows a vehicle 4 which travels through the radar field 2 at a speed v. In the drawing, the vehicle 4 is located at a position in which radar radiation reflected at it leads to determination of a measurement point MP which also lies within the reflection field 2.1. The indicated velocity vector v is directed in driving direction F and forms a second installation angle Ω₂ with the radar axis A.

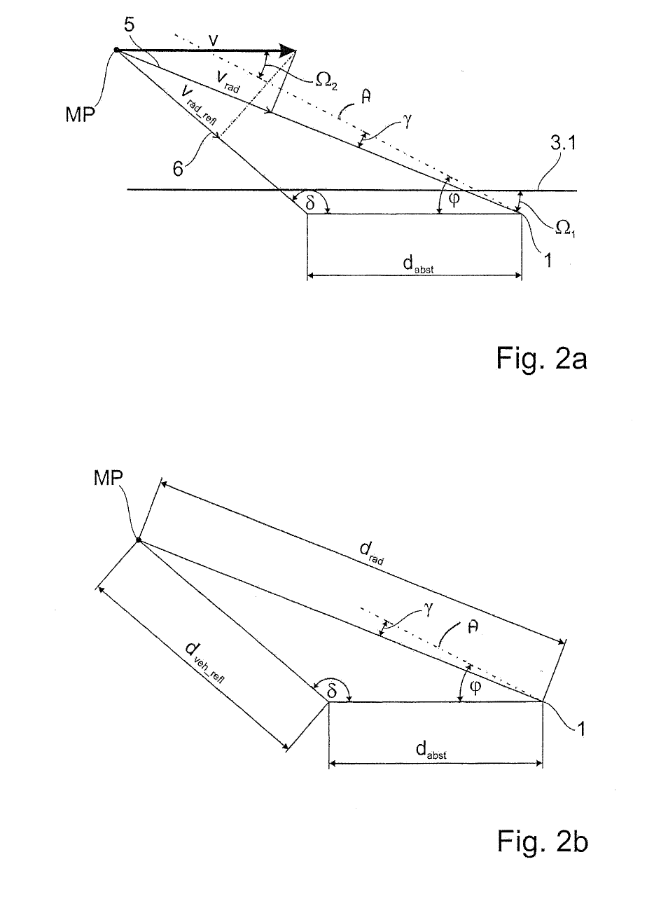

The method according to the invention will be described in the following referring to FIGS. 2a and 2b.

The vehicle 4 can be measured in the radar field 2 at a quantity of measurement points MP (only one measurement point MP is shown by way of example for the sake of clarity), wherein radar radiation impinges directly on the vehicle 4 and, at measurement point MP, is reflected back directly to the radar device 1 as a first portion 5 (represented by an arrow) of the radar radiation along a route describing a direct distance d_{rad} between radar device 1 and measurement point MP. These direct reflection signals are received by the radar device 1 and sent to a computing/control unit 8 by means of which direct measurement data are derived from the direct reflection signals.

A direct radial velocity v_{rad} is measured as direct measurement data. This direct radial velocity v_{rad} is that component of the velocity v of the vehicle 4 that directly faces in the direction of the radar device 1. Moreover, an angle at which the measurement point MP is acquired in the measured direct distance d_{rad} to the radar axis A is measured as direct position angle γ.

With knowledge of the direct radial velocity v_{rad}, the direct position angle γ and the first installation angle Ω₁ or second installation angle Ω₂, the speed v can be derived.

This gives:

v_{rad}=v cos(Ω_{1-γ}) or v_{rad}=v cos(Ω_{2-γ}). 1)

If the speed v is derived at a quantity of measurement points MP, these speeds v can be compared with one another and checked for consistency based on a rule. If the speeds v deviate from one another by at most a certain amount, this is considered proof that all speeds v were derived from a same vehicle 4.

In addition to the direct reflection signals described above, indirect reflection signals are also received by the radar device 1 at the measurement time at which the vehicle 4 is detected at the measurement point MP shown in FIG. 1.

Radar radiation reflected into the reflection field 2.1 by reflector 7 is reflected as second portion (represented by an arrow) of the radar radiation 6 from the measurement point MP along a partial distance dᵥₑₕ_{_{—}}_{refl} to the reflector 7 and from the latter along the installation distance d_{abst} back to the radar device 1.

These indirect reflection signals are received by the radar device 1 and sent to the computing/control unit 8. The indirect radial velocity v_{rad}_{_{—}}_{refl} at which the vehicle 4 moves toward the reflector 7 can be derived from the indirect reflection signals as indirect measurement data.

With knowledge of the indirect radial velocity v_{rad}_{_{—}}_{refl} of the indirect position angle φ and of the driving direction F, the speed v in driving direction F can be derived. This gives:

v_{rad}_{_{—}}_{refl}=v cos(180°−δ−φ+Ω₁) or v_{rad}_{_{—}}_{refl}=v cos(180°−δ−φ+Ω₂) 2)

When a speed v is derived from the direct radial velocity v_{rad} and a speed v is derived from the indirect radial velocity v_{rad}_{_{—}}_{refl}, these speeds v are compared with one another. If the speeds deviate from one another by no more than a certain amount, this can be taken as a first proof that vehicle 4 was not measured by bent beam reflection.

To obtain a further opportunity for checking the derived measurement data, the partial distance dᵥₑₕ_{_{—}}_{refl} is calculated once from the direct measurement data by means of the equation:

$${d}_{veh \_ refl} = \sqrt{{d}_{rad}^{2} + {d}_{abst}^{2} - 2 {d}_{rad} {d}_{abst} cos ( φ - γ )}$$

and stored for later recall. Further, the partial distance dᵥₑₕ_{_{—}}_{refl} is calculated in that an indirect distance d_{rad-refl} is measured as a length of the distance between measurement point MP, reflector 7 and radar device 1, and the installation distance d_{abst} is subtracted from the indirect distance d_{rad-refl}. The lengths of the partial distance dᵥₑₕ_{_{—}}_{refl} calculated along the two paths are compared with one another. If these lengths deviate from one another by no more than a certain amount, this can be taken as a second proof that vehicle 4 was not measured by bent beam reflection

In further embodiments, the checks can also be carried out in that the speeds v and/or partial distances dᵥₑₕ_{_{—}}_{refl} are in a determined mathematical relationship to one another.

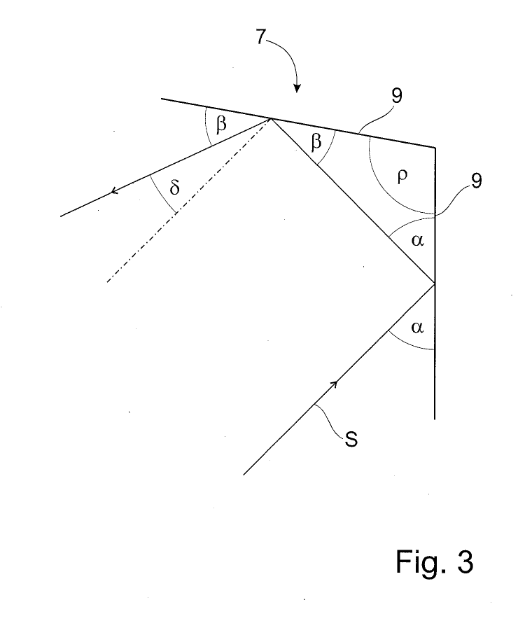

A construction of a reflector 7 according to the invention is shown in a highly schematic manner in FIG. 3. Two reflection surfaces 9 of a modified retroreflector are shown in a top view of the front sides thereof. The reflection surfaces 9 form a reflector angle p that is greater than 90° and less than 180°. The beam path S shows by way of example a beam of a radar radiation impinging on the reflector 7. The beam path S impinges on one of the reflection surfaces 9 at an incident angle α and is reflected thereby onto the other reflection surface 9 on which it impinges at a reflection incidence angle β and is reflected back again by the reflector 7 at the same angle β.

For the angles, this gives:

2α+2β+δ=180°

2α+2β+2ρ=360°

δ=2ρ−180°.

The hypothetical beam path S of a retroreflector at an angle ρ of 90° is indicated by the dashed line. As a result of the reflector 7 configured according to the invention, the radar radiation is always reflected at a reflection angle δ to the impinging radiation diverging from the beam path of a conventional retroreflector by ρ=90° and reflecting impinging radiation back on itself.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

### REFERENCE NUMERALS

1 radar device

2 radar field

2.1 reflection field

3 roadway

3.1 roadway edge

4 vehicle

5 first portion of a radar radiation

6 second portion of a radar radiation

7 reflector

8 computing/storage unit

9 reflection surface

A radar axis

R reflector axis

F driving direction

MP measurement point

S beam path

Ω₁ first installation angle

Ω₂ second installation angle

Ψ alignment angle

v speed (of the vehicle 4)

v_{rad} direct radial velocity

v_{rad}_{_{—}}_{refl} indirect radial velocity

d_{rad} direct distance

d_{rad-refl} indirect distance

d_{abst} installation distance

d_{veh-refl} partial distance

γ direct position angle

φ indirect position angle

ρ reflector angle

α incident angle

β reflection incidence angle

δ reflection angle

What is claimed is:

1. A method for the acquisition of measurement data of a vehicle traveling through a radar field, comprising: directing radar radiation having a radar axis from a radar device horizontally over a roadway thereby defining said radar field, a first portion of the radar radiation impinging said vehicle as it travels through said radar field in a driving direction and being reflected directly back to the radar device, detecting said first portion of the radar radiation by the radar device in the form of direct reflection signals, and deriving measurement data of the vehicle from the direct reflection signals, which measurement data are designated as direct measurement data by reason of their derivation from direct reflection signals, locating and aligning a reflector within the radar field, said reflector having a reflector axis extending perpendicular to the reflector, said reflector axis intersecting said radar axis at an alignment angle, an installation distance of the reflector from the radar device being established when the reflector is located, wherein the installation distance is defined by the shortest distance between the center of the reflector, equal to the intersection of the reflector axis on the reflector, and the center of a reception surface of a radar receiver, equal to the point of intersection of the radar axis, in that a portion of the radar radiation is reflected at the reflector into a reflection field forming a subregion of the radar field so that, simultaneous with the first portion, a second portion of the radar radiation at a vehicle passing through the reflection field is reflected back to the radar device indirectly via the reflector, in that the portion of the radar radiation that is reflected back indirectly is detected in the form of indirect reflection signals, in that measurement data of the vehicle are derived from the indirect reflection signals, which measurement data are designated as indirect measurement data by reason of their derivation from indirect reflection signals, and in that the direct and indirect measurement data which are obtained simultaneously are checked for correlation in order to derive a proof that the direct measurement data and the indirect measurement data are caused by a same vehicle.

2. The method according to claim 1, further comprising, deriving as direct measurement data from the reflection signals, at least at one measurement time, a direct radial velocity, and a direct position angle, said direct radial velocity being that portion of a velocity vector of the vehicle that is directed and measured in direct direction from the vehicle to the radar device, said direct position angle being an angle which lies between the radar axis and a length describing the direct distance between radar device and measurement point and which changes with the movement of the vehicle through the radar field, and deriving as indirect measurement data from the indirect reflection signals, an indirect radial velocity and an indirect position angle, said indirect radial velocity being that portion of the velocity vector of the vehicle that is directed from the measurement point directly to the reflector, said indirect position angle being a measured and constant angle between the radar axis and that distance whose length describes the installation distance, and knowing a first or second installation angle, checking the direct radial velocity and the indirect radial velocity for correlation in order to deduce therefrom, if necessary, as a first proof that the direct measurement data and the indirect measurement data are caused by one and the same vehicle, wherein the first installation angle is an angle between the radar axis and an edge of the roadway, and the second installation angle is an angle between the radar axis and the driving direction of the vehicle.

3. The method according to claim 1, wherein a change in position of the vehicle, and therefore the driving direction of the vehicle, is determined from the measurement data of a plurality of measurement points.

4. The method according to claim 2, wherein the second installation angle is calculated as an angle between the radar axis and the driving direction.

5. The method according to claim 2, wherein the correlation is checked in that a speed of the vehicle in its driving direction is derived from the direct radial velocity on the one hand and from the indirect radial velocity on the other hand, and the derived speeds are then checked for conformity.

6. The method according to claim 2, further comprising deriving a direct distance as direct measurement data and an indirect distance as indirect measurement data and, knowing the installation distance and the position angle, the direct distance and the indirect distance are checked for correlation in order to deduce therefrom, if necessary, as a second proof that the direct measurement data and the indirect measurement data are caused by the same vehicle, wherein the direct distance is determined by the direct path between the radar device and a measurement point, said measurement point being a position of the reflecting surface of the vehicle reduced to a point, and the indirect distance being measured as a total distance from the radar device to the reflector to the measurement point.

7. The method according to claim 6, wherein checking of correlation is carried out by deriving a partial distance from the direct distance on one hand and from the indirect distance on the other hand, and the derived partial distances are checked for conformity.

8. An arrangement for the acquisition of measurement data relating to a vehicle traveling through a radar field comprising a radar device including a radar transmitter and a radar receiver for emitting a radar radiation which is directed over a roadway and which defines a radar field having a radar axis that forms a first installation angle with a roadway edge or a second installation angle with the driving direction of a vehicle, a reflector having a reflector axis which extends perpendicular to the reflector forming an alignment angle with the radar axis, said reflector being arranged and aligned within the radar field at a known installation distance, said reflector being arranged to reflect a portion of the radar radiation via the reflector into a reflection field forming a subregion of the radar field so that the radar receiver receives direct and indirect reflection signals simultaneously at a measurement point of a vehicle traveling through the reflection field, and a computing/storage unit connected to the radar device and configured to derive measurement data from the reflection signals and to check for correlation between these measurement data to derive a proof that the direct measurement data and the indirect measurement data are caused by a same vehicle.

9. The arrangement according to claim 8, wherein the reflector is a retroreflector with reflection surfaces which form a reflector angle with one another that is greater than 90° and less than 180°.
